(19) United States
(12) Patent Application Publication
(10) Pub. No.: US 2014/0107936 A1
(43) Pub. Date: Apr. 17, 2014

(54) CROSS-MODAL APPLICATION OF COMBINATION SIGNATURES INDICATIVE OF A PHENOTYPE

(71) Applicants: Angel Janevski, New York, NY (US); Kamakalaran Sitharthan, Pelham, NY (US); Banerjee Nilanjana, Armonk, NY (US); Varadan Vinay, New York, NY (US); Nevenka Dimitrova, Pelham Manor, NY (US); Sankararaman Suryanarayanan, Westford, NY (US)

(72) Inventors: Angel Janevski, New York, NY (US); Kamakalaran Sitharthan, Pelham, NY (US); Banerjee Nilanjana, Armonk, NY (US); Varadan Vinay, New York, NY (US); Nevenka Dimitrova, Pelham Manor, NY (US); Sankararaman Suryanarayanan, Westford, NY (US)

(73) Assignee: KONINKLIJKE PHILIPS N.V., EINDHOVEN (NL)

(21) Appl. No.: 14/124,076

(22) PCT Filed: May 22, 2012
(86) PCT No.: PCT/IB2012/052551

§ 371 Date: Dec. 5, 2013

Related U.S. Application Data
(60) Provisional application No. 61/493,563, filed on Jun. 6, 2011.

(51) Int. Cl. G06F 19/18

(52) U.S. Cl. CPC G06F 19/18
USPC 702/19

(57) ABSTRACT

The present invention relates to a method of adapting a composite signature of a phenotype. The method comprises the steps of providing for a composite signature of a phenotype with at least two different data types, which were respectively generated by two different modalities of measuring a specimen. Due to an adaption of one part of the signature of the phenotype the resulting adapted phenotype signature can be used as an input for a signature evaluation tool that was derived from data measured by a third modality of measurement.

### FIELD OF THE INVENTION

The present invention relates to phenotype description using multiple data types. In particular, the present invention relates to a method of adapting a composite signature of a phenotype, a program element for adapting a composite signature of a phenotype and a computer-readable medium in which a program element is stored.

### BACKGROUND OF THE INVENTION

The advent of new measurement technologies and a deeper understanding of biology and disease mechanisms have led to novel approaches to a better stratification of patient samples into phenotype groups. In addition to advances in the clinico-pathological assessment of biological tissue, high-throughput molecular profiling technologies in recent years has provided unique insight into the underlying molecular and biological processes in normal as well as diseased specimen. Particularly, molecular profiling has enabled understanding of processes in cancer onset and development as well as possible approaches to personalized therapy primarily based on molecular signatures of individuals. There have been investigations into correlating molecular profiles with other data types typically available in the clinic starting with basic demographic data, pathology, molecular diagnostic tests, and several types of imaging. There has been some success in assisting clinicians and patients in making diagnosis and therapy decisions using molecular profiles. It might be of interest in the future to combine multiple (molecular and other) data types. In this spirit there have been initial investigations in complete in clinic-pathological data and high-throughput molecular profiles with imaging. Such tools would enable clinicians to interpret findings using one data type that are optimized and enhanced by other (complementary) data type at the discovery stage. For example, an MRI reading of a breast lesion would have superior interpretation when additional input is used by genomic profiling from a clinical study that indicates that lesions with certain properties that would otherwise be interpreted as non-invasive are known to be invasive. The genomic profiling may include transcription profiling (gene and noncoding RNA profiling), SNPs, CNPs, proteome profiling, DNA methylation, histone methylation and acetylation as well as phosphorylation states. Alternatively, a combination of a genomic profile of a biopsy specimen and an MRI imaging in conjunction may predict response to therapy with higher accuracy than any of the measurements alone. In a specific example, e.g. a neo-adjuvant therapy study in breast cancer, data is acquired at three different time points: the first time point is at diagnosis, e.g. T=0 days, an MRI image is produced as well as a molecular profile of a biopsy. The second time point may be shortly after administration of the therapy, e.g. T=10 days, where an MRI image is produced as well as molecular profile of biopsy. At the third time point at surgery, e.g. T=12 weeks, an MRI image is generated as well as a molecular profile of the removed cancer object.

Based on the molecular profiles, imaging data, and the clinical-pathological assessment, a ground truth is established whether at the second time point there is a response to the therapy leading to remission at the third time point. Once this is established, imaging features like for example volume, or dynamic property that best correlate to the response are selected which can then be used in future practice without the invasion at the second time point.

However, the expensive and heavy measurement apparatuses of for example an MRI apparatus may not always be available when the above described measurements should be made. That means that not always the most reliable combination of measurement modalities can be combined by the examining clinicians.

### SUMMARY OF THE INVENTION

There may be a need to provide for facilitated analysis of a phenotype using multiple data types describing the phenotype.

The object of the present invention is solved by the subject-matter of the independent claims, wherein further embodiments and advantages are incorporated in the dependent claims.

It should be noted that the following described aspects of the invention apply mutatis mutandis also for the program element and the computer-readable medium.

According to an exemplary embodiment of the invention, a method of adapting a composite signature of a phenotype is presented. The method comprises the steps of providing for a composite signature of a phenotype, wherein the composite signature comprises data of type A which were generated by measuring the specimen with a first modality of measuring and wherein the data of type A comprise values of modality features a₁ . . . a_{q}. The composite signature further comprises data of type B which were generated by measuring the specimen with a second modality of measuring. The data of type B comprise values of modality features b₁ . . . bₖ. The method further comprises the step of adapting the value of the feature bᵢ based on a determined correlation between the value of feature bᵢ and between the value of a feature cⱼ of the phenotype which feature cⱼ is measured with a third modality of data type C. Thereby, bᵢ is out of b₁ . . . bₖ. Furthermore feature cⱼ may be out of c₁ . . . c₁. Further, the adaption leads to an adapted composite signature. Further the method comprises the step of applying a signature evaluation tool to the adapted composite signature, wherein the evaluation tool was derived from data measured by the third modality.

Thereby the adaption may be carried put with respect to different modalities of measurement for the same sample and/or patient or could be applied over time.

In the context of the present invention the term “phenotype” is used a “clinical phenotype”. This stresses the difference to a classical phenotype.

Furthermore the “phenotype” is not explicitly measured but is derived based on measurements of a specimen and/or a patient. The term “phenotype” may be seen as the clinical interpretation of a measurement of a specimen and/or a patient. For example, a nodule in an MRI Scan can be interpreted as the phenotype benign or malignant tumor, but also can be linked to a phenotype describing the outcome (e.g. chance of survival in 5 years). In other words a clinical phenotype is an abstract representation from the measurements of a specimen. Thus, it is distinguished in the context of the present invention between the object what is measured and between the interpretation of the signature composed of these measurements.

In the context of the present invention the term “specimen” is simultaneously used for sample and/or patient. Furthermore the term “specimen” shall be understood in the context of the present invention as an object that is examined and thus measured by a person by means of a measuring modality. For example an object of tissue of a human being may be seen as a “specimen”. Alternatively any kind of a cancer object may be seen as a “specimen” according to the wording of the present invention. However, the term “specimen” is to be understood as being not delimited to these examples.

In other words a “phenotype” may be seen as a definition of any observable characteristic of an organism determined by the genotype and the environment. A “clinical phenotype” may be seen as set of descriptions, which could be derived from a measurement or a clinical observation of a specimen by a clinician. The measurement or the observation can be associated with clinical condition or e.g. a status of a disease. For example, triple negative phenotype in breast cancer which refers to breast cancer with ER- PR- and Her2-status. Subsequently a model that corresponds to a clinical phenotype can be captured or generated by one or more measurements starting at overall patient characteristic such as e.g. age and other comorbidities, organ level from e.g. diagnostic imaging to tissue level from e.g. pathology observation to molecular level from e.g. high resolution sequencing. These measurements are derived from a number of diagnostic measurement modalities, each providing its own set of relevant features that may later be used in creating models that explain a particular clinical phenotype.

A “phenotype” may be understood as a class or category of specimen that have certain properties and fulfil certain criteria. A phenotype may for example be a certain type of breast cancer with certain properties. This phenotype may be called e.g. breast cancer type A1. A sample of tissue of a patient, i.e. the analyzed specimen may be classified into such a phenotype class or may be classified into another different class or category.

In other words, the present method provides for a signature of a phenotype that comprises multiple data types. The present invention further provides for an evaluation or calculation of the nature of the measured or analyzed specimen.

The term “signature” data may comprise e.g. the shape of a tumor plus a gene that is highly expressed.

The presented method makes use of an already existing “signature evaluation tool” of a third modality and adapts data that has been measured by means of another modality of measuring in such a way that the adapted composite signature can be used with the existing signature evaluation tool. Although the signature evaluation tool corresponds to the third modality and although the composite signature originally was measured by means of two other modalities of measuring the specimen, it is possible to apply the existing signature evaluation tool to the adapted composite signature and therefore evaluate the available data correspondingly. In other words, the presented method may be seen as a method to calculate a predictive result about the nature of the specimen or phenotype by means of a signature evaluation tool or a model of a third measurement modality without having the need to provide for measurement data of the specimen generated by the third measurement modality. Thus, the signature evaluation tool may be seen as machine or kind of an algorithm. The signature evaluation tool may also be previously derived from data measured by the third modality and from data measured by the first modality. In this case, the signature evaluation tool corresponds to the first and third modality. For example the signature evaluation tool may be a model for a composite signature, which signature consists of firstly genetic profiling data and secondly MRI data. The use of such an already existing model for a currently measured composite signature that consists of firstly genetic profiling data and secondly ultrasound data is possible due to the present invention.

Furthermore, the term “signature evaluation tool” may be seen as a model or as an algorithm, which may take the composite signature as an input and may output a result in form of data.

Thereby, the term “modality of measuring” may also be seen as a modality of examining or analyzing the specimen. For example, a modality of measuring may be ultrasound imaging of the specimen, MRI imaging of the specimen or genetic profiling of the specimen. But also other measuring modalities or detection modalities are comprised within the invention. Moreover, in the following the terms “measurement modality” and “modality of measurement” are used as synonyms.

Furthermore genomic profiling may be a modality of measuring which may include transcription profiling (gene and noncoding RNA profiling), SNPs, CNPs, proteome profiling, DNA methylation, histone methylation and acetylation as well as phosphorylation states. Furthermore genetic profiling could be gene expression profiling, copy number polymorphism profiling, single nucleotide polymorphism profiling, DNA methylation, histone methylation profiling, histone acetylation profiling, proteomic profiling, phosphorylation state profiling, etc.

The term “determining the correlation between the value of feature bᵢ . . . ” is in the context of the present invention synonymously used with the term of mapping features of one modality with features of another modality.

Moreover, the term “determining” comprises to make use of a correction factor as will be described below. Also the term “adapting” comprises to adapt by applying or multiplying the correction factor.

Therefore, the presented method may be seen as a method for transforming a composite signature of a phenotype and adapting it in such a way, that a signature evaluation tool or a model of a third measuring modality can be applied to the adapted signature phenotype, which results in a predictive result about the phenotype of the measured specimen.

Thereby, the invention takes the advantage of phenotype description using multiple data types. Specifically, the method may be seen as a transitive approach in which the finding of a third modality of measuring, which finding has been integrated into the signature evaluation tool of the third modality, is now used for data, that has been generated by a second modality of measuring.

Furthermore, the presented method may also include the step of measuring the data of type B by a second measurement modality. The presented adaption of the value of feature bᵢ based on the predetermined correlation may also be done for a plurality of features b.

The presented method enables the translation of part or of the entire signature from one data type (corresponding to one modality) to a more or less related modality with minimal loss of information. Given two or more data types of two different measuring modalities that constitute a molecular profile of a phenotype that corresponds to the measured specimen, a mapping between the second modality used for measuring the phenotype and the third modality selects which features in the second modality are best used. The first and third modalities of measuring were previously used to generate the signature evaluation tool, which may be seen e.g. as a numerical model. For example a signature evaluation tool, or a model, could previously have been generated based on firstly genetic profiling data and secondly on MRI data. In case of an examination of a patient where only biopsy and ultrasound measurements as first and second modalities of measuring are available for the clinician, the present invention enables the clinician to use the already generated model, also no MRI data can be generated from the present patient, i.e. from the present phenotype which has presently to be examined. Furthermore an optimization algorithm may determine how these features translate into the third modality, i.e. in the MRI modality for the previously described example. Then, a new composite signature may be output with values of features measured by the third modality. Based on such algorithms and translations a more general translation is derived to extrapolate mappings to procedures and phenotypes where the data, e.g. imaging data, of the third modality was not acquired in the course of the development of the composite signature.

With this approach, findings from a study that has the resources to explore the measurements to a great extent can be extended to a population of patients and clinicians that would otherwise be unable to benefit from the clinical knowledge and tools. For example, a breast cancer imaging marker is developed using coordinated MRI imaging and biopsy sample genetic profiling. Based on the molecular profile of the biopsy the optimal set of imaging features may be chosen to assist the radiologist in assessing lesions. This tool however might only be used with input of the same data type as in the original study. The present invention enables clinicians to apply clinical knowledge without the limitation of the available modality (measurement technology) or even use additional modalities to further clarify a finding and proceed with the optimal clinical step. In other words, the present invention makes use of an already existing signature evaluation tool, which has been generated from a relatively long-term study based on data of the third measurement modality.

Furthermore, a gist of the invention may be seen as to provide for the ability to scale down the instrumentation requirements of a clinical step while at the same time the benefits of a sophisticated test is retained. For example, molecular and imaging data types may be used, but also other measurements can certainly be used within a similar fashion by means of the present invention.

If desired or needed, the already existing signature evaluation tool or model may be adapted in order to improve the applicability of the tool to the second measuring modality. This will be explained with regards to an example within the description of the drawings. In other words according to this exemplary embodiment, the method further comprises the step of adapting the signature evaluation tool before applying it to the adapted composite signature.

According to a further exemplary embodiment of the invention, the method further comprises the step of determining the correlation between the value of feature bᵢ which is out of b₁ . . . bₖ and between the value of a modality feature cⱼ, wherein the indexed features “c” represent features that are measured with the third modality. As can exemplarily gained from the following a correction factor may be used to map the values of feature bᵢ to the value of a modality feature cⱼ. One or more correction factors describe how a value of a feature that is measured with the second modality correlate to a feature that is measured with the third modality. For example the correction factor may describe how features or values of a of a cancer object that is measured with an ultrasound imaging device correlate to features or values of feature when the cancer object is measured with an MRI device. Such a determined correlation might be defined by the present invention for a plurality of features bᵢ and a plurality of features cⱼ. These correlations may be entries of a mapping matrix which will be described later on.

Therefore, the step of adapting the value of the feature bᵢ may be seen as applying the correction factor to the value of the feature bᵢ. For example, a multiplication may be used, but also other calculation methods shall be comprised by the invention.

According to a further exemplary embodiment, the correlation defines how values of modality features b₁ . . . bₖ measured with the second modality match or correlate with values of modality features cⱼ which are measured with the third modality. In other words the correlation defines how values of features b₁ . . . bₖ of the second modality match or correlate with values of features cⱼ of the third modality.

It shall be noted, that for carrying out the present invention a measuring of the specimen by means of the third modality of measurement is not necessary. Before the present invention is carried out or applied the above described correlation may be constituted, defined, determined or specified by a user or by a computer program. After such a correlation is found the method of adapting the composite signature of a phenotype is started. If desired, the determination of this correlation can also be a step of this method.

In other words, this exemplary embodiment takes advantage from the previously defined correlation between the features of a specimen or a phenotype when they are measured with different measuring modalities.

According to a further exemplary embodiment, the second modality of measuring is a first medical imaging method and the third modality of measuring is a second medical imaging method. For example, a composite signature of a phenotype may comprise data of a genetic profiling procedure and may comprise data of an ultrasound image of the phenotype. Genetic profiling in this case is the first modality of measuring, wherein the ultrasound imaging is the second modality of measuring and is the first medical imaging method. The present invention now enables a user to adapt this composite signature of the phenotype in such a way, that a signature evaluation tool, e.g. a numerical model, which is generated to evaluate data of MRI images can be used to evaluate also this adapted composite signature of the phenotype. This is possible although no MRI image has been generated for this present specific phenotype. Therefore, in this case the third modality of measuring is to be seen as the MRI imaging which is the second medical imaging method according to this exemplary embodiment.

According to another exemplary embodiment of the invention, the method comprises the step of calculating a result about the nature of the phenotype based on the application of the signature evaluation tool to the adapted composite signature.

For example, if the measured or examined phenotype is an object of cancer, the type of recurrence risk may be calculated by the present method. This calculation may be done by e.g. the signature evaluation tool of the third modality. However, if desired the result may also be calculated separately.

According to another exemplary embodiment, the determination of the correlation is performed for several features b₁ . . . bₖ with respect to several features cⱼ. The method further comprises the step of selecting the features out of b₁ . . . bₖ whose determined correlation indicate a match with a feature cⱼ which match is above a predefined threshold. This may be seen as a step of translation.

The second and third modality of measuring may be of similar kind, for example they may be two imaging modalities. The “match” between the features may be characterized by weight (e.g. by values from 0 to 1) to signal the strength of the match between the two features. For example, the diameter of the phenotype in MRI and ultrasound readings would have a strong match (e.g. 1.0), while a particular pair of texture assessment tools would have a weaker match (e.g. 0.3).

According to a further exemplary embodiment, the step of providing for a mapping matrix with matrix elements bcᵢⱼ and providing for the composite signature of a phenotype in a vector form.

The matrix elements bcᵢⱼ respectively indicate the determined correlation between the values of the features bᵢ and cⱼ. Such a matrix may completely describe the match which was described with respect to the previously presented embodiment. The description may make use of the values between 0.0 and 1.0. Thereby, 0.0 would signal that those two features do not correspond to each other whereas 1.0 would signal a perfect or total match. This may for example be applied to various contrast and non-contrast based imaging modalities including functional imaging. However, this exemplary embodiment is not limiting the scope of invention, as this is just one embodiment and there certainly other models for mapping between two modalities as will be apparent from the above and following description.

According to a further exemplary embodiment, the data of type A are genetic clinic-pathological data. The method further comprises the step of keeping the clinic-pathological data unchanged during carrying out the method. For example, the clinic-pathological data can be genetic profiling date.

In other words, the composite signature of the phenotype is only partially adapted by this exemplary embodiment of the present invention. The part of the data which represents the genetic profile information is kept constant during the execution or performance of the method, whereas the data part of the signature which was generated by the second modality of measuring like for example an imaging method is adapted as defined in the claims. Therefore, only a part of the composite signature is mapped and/or translated between the second and the third modality. The adaption of the features measured with the second modality and the selection which features are best used is only performed in the group of data of type B according to this exemplary embodiment.

According to another exemplary embodiment, the phenotype is a cancer object and the method comprises the step of calculating a recurrence risk of the cancer object by applying the signature evaluation tool to the adapted composite signature of the cancer object.

In other words, a recurrence risk is calculated by means of using the already existing signature evaluation tool, e.g. a model, of the third modality of measurement when it is applied to the adapted composite signature of the presently analyzed specimen. For example, a breast cancer imaging marker is developed using coordinated MRI imaging and biopsy sample genetic profiling. In other words breast cancer imaging marker is to be seen as a model. More precisely, the model is a marker based on both modalities: coordinated MRI imaging and biopsy sample genetic profiling. If a clinician now is only able to produce for example ultrasound imaging data the present invention enables the clinician to a molecular profile and ultrasound imaging signature of a specimen to be used as an input for the already existing evaluation model that is based on MRI imaging. Thus, MRI imaging in this case corresponds to the third measuring modality. The already existing breast cancer imaging marker may only be used with the input of the same data type as in the original study. The invention enables the clinician to apply clinical knowledge without the limitation of the available modality or even use additional modalities to further clarify a finding and proceed with an optimal clinical step. In detail, the present method of adapting the signature of the phenotype adapts the type B data of the signature in such a way that it can be used for the above-described MRI tool, although no MRI image or data has in this specific situation been generated from the phenotype which has to be analyzed.

According to another exemplary embodiment of the invention a medical imaging apparatus for adapting a composite signature of a phenotype is presented, wherein the medical imaging apparatus comprises a receiving section which is adapted to receive data of type A which were generated by measuring the specimen with a first modality of measuring. The medical imaging apparatus further comprises an imaging device adapted to generate data of type B by measuring the specimen with a second modality of measuring, wherein the medical imaging apparatus is configured to generate a composite signature of the phenotype. Thereby the composite signature comprises data of type A and type B, wherein the data of type A comprise values of modality features a₁ . . . a_{q}, wherein the data of type B comprise values of modality features b₁ . . . bₖ. Furthermore the medical imaging apparatus is configured to adapt the value of the feature bᵢ based on a predetermined correlation between the value of feature bᵢ and between the value of a feature cⱼ when measured with a third modality, wherein feature bᵢ is out of b₁ . . . bₖ. The medical imaging apparatus is further configured to generate an adapted composite signature, wherein the medical imaging apparatus is configured to apply a signature evaluation tool to the adapted composite signature and wherein the evaluation tool was derived from data measured by the third modality.

For example the medical imaging apparatus may comprise a computer program element which makes it possible to execute the above described methods of adapting a composite signature of a phenotype on this medical imaging apparatus.

According to another exemplary embodiment, a program element for adapting a composite signature of a phenotype is presented which program element, when being executed by a processor is adapted to carry out the steps of: receiving a composite signature of a phenotype in form of data, adapting the value of the feature bᵢ which is out of b₁ . . . bₖ based on a determined correlation between the value of feature bᵢ and the value of a feature cⱼ which was measured by a third modality and applying a signature evaluation tool to the adapted composite signature wherein the composite signature comprises data of type A which were generated by a first modality of measuring the specimen. Furthermore, the data of type A comprises values of modality features a₁ . . . a_{q}, and the composite signature comprises data of type B which were generated by a second modality of measuring the specimen. Furthermore, the data of type B comprise values of modality features b₁ . . . bₖ and the adaption leads to an adapted composite signature. Furthermore, the evaluation tool is derived from data previously measured by the third modality.

The computer program element may be part of a computer program, but it can also be an entire program by itself. For example the computer program element may be used to update an already existing computer program to get to the present invention.

According to another exemplary embodiment, a computer-readable medium, in which a program element for adapting a composite signature of a phenotype is stored, which, when being executed by a processor is adapted to carry out the steps of: receiving a composite signature of a phenotype in form of data, adapting the value of the feature bᵢ which is out of b₁ . . . bₖ based on a determined correlation between the value of feature bᵢ and the value of a feature cⱼ which was measured by a third modality and applying a signature evaluation tool to the adapted composite signature wherein the composite signature comprises data of type A which were generated by a first modality of measuring the specimen. Furthermore, the data of type A comprises values of modality features a₁ . . . a_{q}, and the composite signature comprises data of type B which were generated by a second modality of measuring the specimen. Furthermore, the data of type B comprise values of modality features b₁ . . . bₖ and the adaption leads to an adapted composite signature. Furthermore, the evaluation tool is derived from data previously measured by the third modality.

It may be seen as a gist of the invention to provide for a method which enables a clinician to use a signature evaluation tool, e.g. a model, which is based on measurements of a third measuring modality, for a composite signature of a phenotype which does not comprise data that is generated by the third measurement modality. This may be done e.g. by partially adapting the data of type B and thereby using a correlation between the features of the specimen when measured with the second and third modality.

These and other features of the invention will become apparent from and elucidated with reference to the embodiments described hereinafter.

### BRIEF DESCRIPTION OF THE DRAWINGS

Exemplary embodiments of the invention will be described in the following drawings.

FIGS. 1 to 3 are flow diagrams which schematically show methods of adapting a composite signature of a phenotype according to exemplary embodiments of the invention.

FIG. 4 schematically shows a mapping matrix of MRI features to ultrasound features as used in a method according to an exemplary embodiment of the invention.

FIG. 5 schematically shows an adaption of a composite signature of a phenotype according to an exemplary embodiment of the invention.

FIG. 6 schematically shows a medical imaging apparatus, a computer system and a program element according to different exemplary embodiments of the invention.

### DETAILED DESCRIPTION OF EMBODIMENTS

In general, a composite signature consists of information of data type A and data type B. Features in these data types (aᵢ from A and bⱼ from B) have been selected and optimized to enable classification into different phenotypes. Such a composite signature may then be represented as S=<aᵢ . . . a_{q}, b₁ . . . bₖ>. In case data type B needs to be translated to a modality of measuring of data type C the following may be applied. Two key steps may be required to do so. First, a subset of the B type features may be selected between modalities B and C. Subsequently, a translation T may be applied to this subset or to the modified signature where A type features are taken with the subset of C type features: S′=<c₁ . . . cᵣ> or S′=a₁ . . . a_{q}, c₁ . . . cᵣ>. In other words the data of type A is kept constant during performing the method according to this exemplary embodiment of the invention. An interesting sub-case is when C=B, where in other words we would take the strongest features from the data type B input and drop those that are less informative.

Data from which a signature is derived are typically obtained in clinical studies where a number of participants are systematically tracked over a period of time to establish the description of a relevant phenotype. For example, 200 newly diagnosed breast cancer patients are tracked over several years for recurrence of the cancer. Each patient may be documented with an initial imaging study (e.g. MRI) and biopsy sample. Based on this, clinic-pathological data as well as molecular profiling data is available for each patient. From the follow-up data, a clinical phenotype can be derived (e.g. patients with recurred cancer and patients without at five years after diagnosis). Imaging features, clinic-pathological data, and genomic data is then used to derive a signature evaluation tool, e.g. a numerical model that predicts the nature of the phenotype based on all available features or a subset of all available features. In one simple example, one may image a signature consisting of two imaging features and expression levels of three genes: S=<G1,G2,G3,I1,I2>. An example of a signature evaluation tool, or a model, is as follows: the signature evaluation tool or model define that the outcome O as O=G+I. G=1 if one or more of the genes are expressed above the same threshold otherwise G=0. Furthermore, I=1 if both I1 and I2 are above some set thresholds, otherwise I=0. For example, if I1 is the diameter of a nodule, then 1 cm is one example of a threshold, and I2 characterizes the contrast washing rate via signal increase. Similarly, 70% is an example of a threshold for I2. Then, the model derived states that O=2 is high recurrence risk, O=1 is medium recurrence risk and O=0 is low recurrence risk. A model then is set to predict the output with some accuracy, e.g. 98%.

The step of mapping the features of a phenotype between two measurement modalities may be described as follows: Features available from each modality are determined by the tools that are used to analyze the data like e.g. diameter, volumes or texture in images. Additionally, the “match” between the features is characterized for example by weight (e.g. from 0 to 1) to signal the strength of the match between the two features. In another example from imaging, diameter and MRI and ultrasound readings would have a string match (e.g. 1.0), while a particular pair of texture assessment tools would have a weaker match (e.g. 0.3). In one above and subsequently described embodiment, a matrix with elements bcᵢⱼ can completely describe this match. This approach might for example apply to various contrast and non-contrast based imaging modalities including functional imaging.

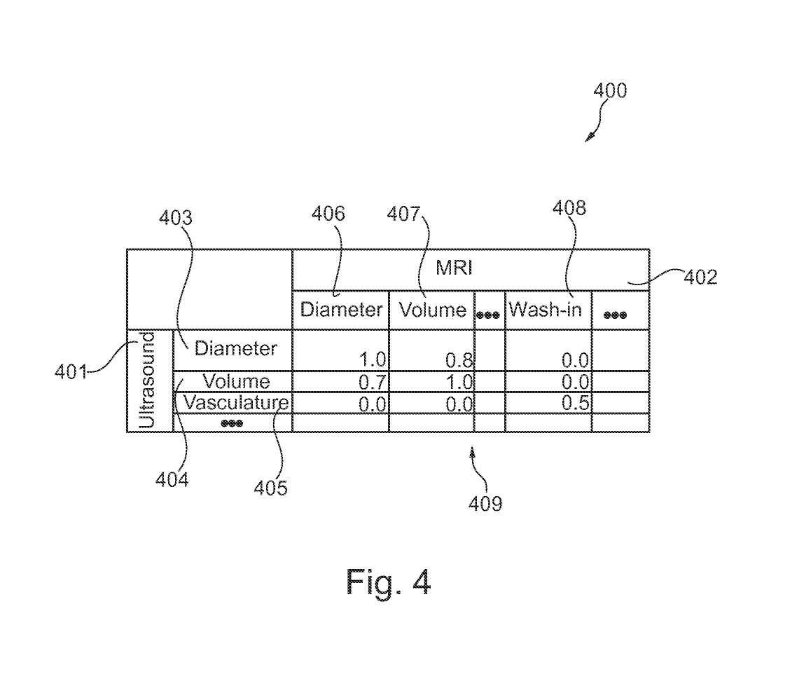

In order to translate the composite signature, the present invention utilizes a mapping of features between second and third modality of measuring. For example in FIG. 4 a table shows how MRI features may map to ultrasound features. Therefore, FIG. 4 shows a table 400 with an ultrasound column 401 comprising several modality features 403, 404 and 405, wherein the ultrasound being the measurement modality. Furthermore, an MRI line 402 is comprised in the table 400 in which several modality features 406, 407 and 408 are comprised. The MRI being the measurement modality. The entries 409 in the respective column and lines indicate and represent the strength of matching between the corresponding features. Thereby, the ultrasound imaging and the MRI imaging correspond to the second and third modality according to the present invention. Ultrasound measurements may provide some similar imaging features like for example diameter and volume, but also other features that are not directly measured with MRI. Here Doppler ultrasound measures fraction of the tumour area carrying blood flow. Now an adapted composite phenotype signature based on G1, G2, G3,I′1 and I′2, where I′1 may be the diameter (same threshold as MRI), and I′2 may be vascular (with a threshold of e.g. 3%) measured by ultrasound.

In a further translating step the feature or features cⱼ are selected e.g. simply from a threshold for example >0.2 from the above-described table. The above-described table might also be presented within a bcᵢⱼ matrix.

If desired, the process by means of which the original composite signature was obtained may be repeated. Also training samples of matching phenotypes may be used.

Finally, to obtain the new signature evaluation tool or new model O′, we first built the new adapted signature S′. The mapping M maps MRI diameter to an ultrasound diameter and MRI wash-in to ultrasound vasculature. The translation T will then utilize G1, G2 and G3 as before (G′=G). Then, I′1 and I′2 are used to obtain I′ when I′1 and I′2 are both above their thresholds. In other words, O′=G′+I′=G+I′. In other words according to this exemplary embodiment, the method further comprises the step of adapting the signature evaluation tool before applying it to the adapted composite signature.

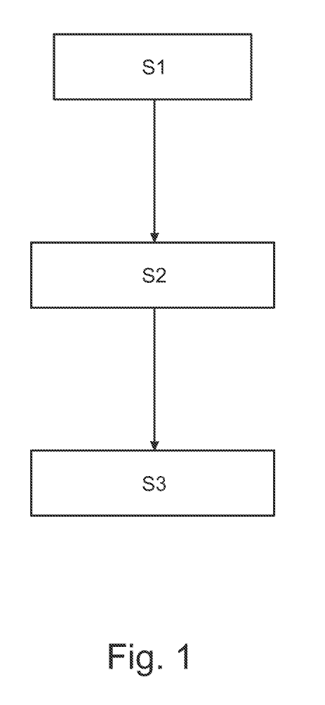

FIG. 1 shows the method of adapting a composite signature of a phenotype according to an exemplary embodiment of the present invention. In a first step S1 a composite signature of a phenotype is provided, wherein the composite signature comprises data of type A which were generated by measuring a specimen with a first modality of measuring. Thereby, the data of type A comprises values of modality features a₁ . . . a_{q}. Furthermore, the composite signature comprises data of type B which were generated by measuring the specimen with a second modality of measuring. The data of type B comprises values of modality features b₁ . . . bₖ. Furthermore, the second step S2 is shown in FIG. 1 which is adapting the value of the feature bᵢ based on a previously determined correlation between the value of feature bᵢ and between the value of a feature cⱼ when measured with a third modality. Thereby, the adaption leads to an adapted composite signature. In addition the third step S3 is shown in FIG. 1 which is applying a signature evaluation tool to the adapted composite signature, wherein the evaluation tool was derived from data measured by the third modality. With this method, findings from a study that has the resources to explore the measurements to a great extent can be extended to a population of patients and clinicians that would otherwise be unable to benefit from this clinical knowledge and tools.

A possible application of this invention is a clinical diagnostic setting where typically multiple data types are acquired. In an example medical imaging methods and imaging data types are described but also other measurements can certainly be used with when performing the inventive method. An advantage of the present invention is the ability to scale down the instrumentation requirements of a clinical step while at the same time retaining the benefits of a sophistic test of a phenotype. For example, a signature is used in which the data of type A is generated by a sequencing technology which is cheap and portable. However, in cases where MRI is unavailable (e.g. care provided in remote area, equipment not affordable) and an ultrasound image is used to provide imaging data to a composite signature an evaluation tool, which has already been generated based on MRI pictures may be used due to the present invention. In order to benefit from this desired flexibility, the present invention teaches to adapt the value of the feature b₁ of the composite signature correspondingly and further teaches to apply the already existing signature evaluation tool to adapt the composite signature. If desired, the signature evaluation tool which was generated e.g. on a study of MRI pictures may also be adapted correspondingly in order to optimize the tool for a present composite signature that comprises ultrasound data.

As another example of an application of the invention, the following situation is described: an already existing evaluation tool is based on MRI images and molecular sequencing. In case sequencing is not available (e.g. not practical to perform entire genome sequencing) a simpler and cheaper test to derive similar information may be desirable. After having performed such a simpler and cheaper test the entire composite signature of the phenotype might be adapted as described with respect to independent claim 1 and furthermore a signature evaluation tool may be applied to the adapted composite signature.

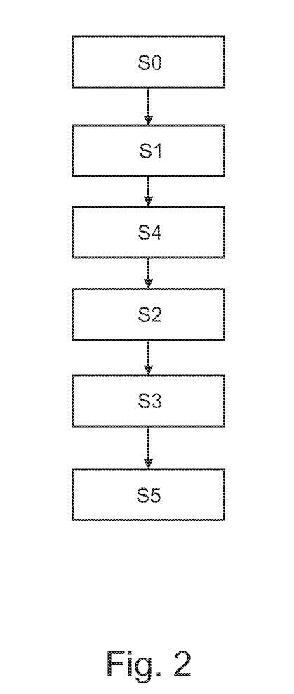

FIG. 2 shows another flow diagram of a method of adapting a composite signature of a phenotype according to an embodiment of the invention. During step S0 data of type A and data of type B are generated by measuring the specimen with the first and second modality of measuring. The step of providing for a composite signature of a phenotype is shown within step S1. The step of determining a correlation between the value of the feature bᵢ which is out of b₁ . . . bₖ and between the value of a feature cⱼ when measured with a third modality is shown with step S4. Furthermore, the step of adapting the value of the feature bᵢ based on the previously determined correlation is performed by the method and is shown in FIG. 2 by S2. This adaption depicted by step S2 leads to an adapted composite signature, which has in the above description be defined as S′. A signature evaluation tool, which can be seen as a model is applied to the adapted composite signature which step is shown by S3. Thereby, the evaluation tool was derived from data measured by the third modality. In other words, the signature comprises data of the first and second modality but although the third modality is not used within this exemplary embodiment of the invention the signature evaluation tool which was derived from data of the third modality of measurement can be used for such a signature of a phenotype. Additionally the step S5 is shown which represents the step of calculating a result about the nature of the phenotype based on the application of the signature evaluation tool to the adapted composite signature. Therefore, especially in cases of cancer diagnosis the present invention may realize the ability to scale down the instrumentation requirements of a clinical step while at the same time retaining the benefits of a sophisticated test about or on the phenotype.

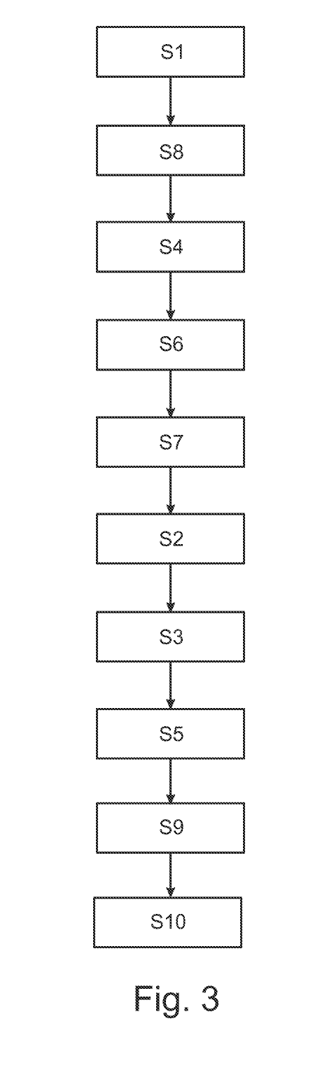

FIG. 3 shows another flow diagram of a method of adapting a composite signature of a phenotype according to an embodiment of the invention. In a first step S1 a composite signature of a phenotype is provided. In this embodiment the signature is provided in form of a vector which is shown by S8. The step S4 describes the determining or defining the correlation as already explained with respect to FIG. 2. S8 describes selecting the features out of b₁ . . . bₖ whose determined correlation indicate a match with a feature cⱼ, which match is above a predefined threshold and therefore the matching strength is large enough. The step S6 might be part of the above-described step of translating as will also be described in the following.

In FIG. 3 the shown diagram comprises the step of providing for a mapping matrix with matrix elements bcᵢⱼ which is represented by S7. By means of the mapping matrix an adaption of the value of the feature bᵢ based on the entry of the matrix is performed, which is shown in FIG. 3 by step S2. This leads to an adapted composite signature. Step S3 describes applying a signature evaluation tool to the adapted composite signature wherein the evaluation tool was derived from data measured by the third modality. If desired, a result may be calculated about the nature of the phenotype which calculation is based on the application of the signature evaluation tool to the adapted composite signature and which is shown in FIG. 3 by S5. The shown flow diagram of FIG. 3 may be applied to phenotype descriptions which use multiple data types. For example, the original composite signature which is provided in step S1 may be comprised of data type A which is generated by a genetic profiling method and data type B which is generated by a medical imaging method. However, other combinations are possible. In FIG. 3 step S9 describes the step of keeping the genetic profiling data unchanged during the method. In other words, only the part of the composite signature, which comprises data of an imaging method is adapted, mapped and/or translated according to the present invention. Due to the constant and unchanged genetic profiling data in the composite signature the output of the application of the signature evaluation tool is reliable.

Furthermore, the embodiment of FIG. 3 describes a method in which the examined phenotype is cancer. Step S10 describes the calculating a recurrence risk of the cancer by applying the signature evaluation tool to the adapted composite signature. As previously described the signature evaluation tool may be configured to calculate a level of recurrence risk of cancer. An exemplary output of the calculation may be O=2 for high recurrence risk, O=1 for medium recurrence risk and O=0 for low recurrence risk. But also other levels are possible.

FIG. 4 shows a table 400 in which mapping entries 409 are entered, which represent or describe the correlation between features when measured by ultrasound 401 and features when measured with MRI 402. Further details about the table 400 have been explained in the foregoing.

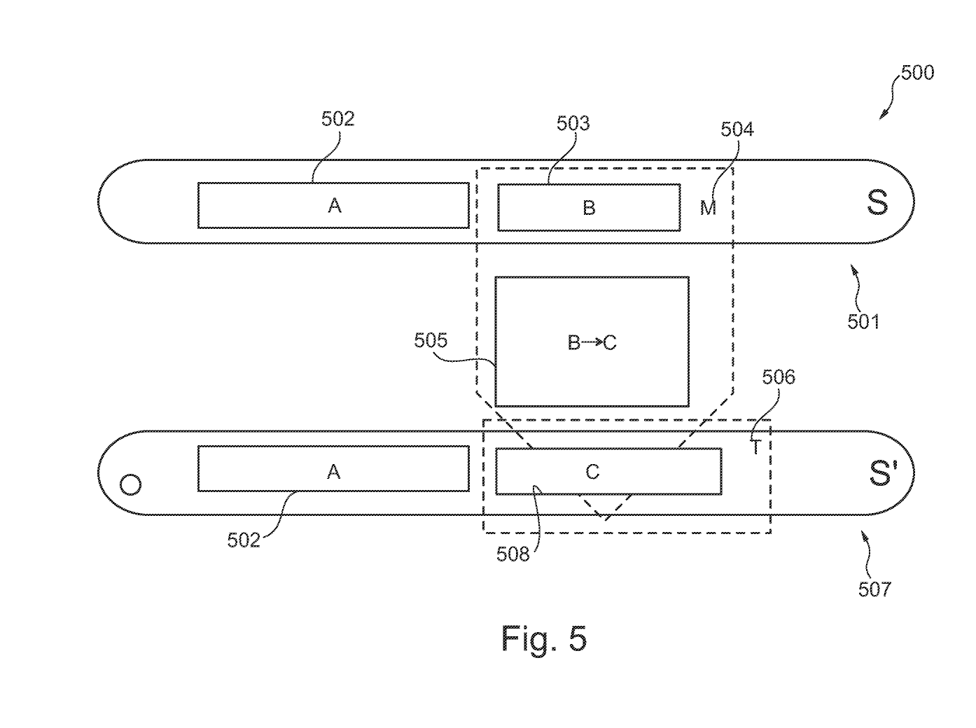

FIG. 5 shows an adaption step 500 which may be part of an exemplary embodiment of the invention. In the beginning S 501 is shown which comprises data of type A depicted by 502 and data of type B depicted by 503. Only the data of type B is adapted during the method of adapting the composite signature according to this exemplary embodiment. For example, data of type A may be molecular profiling data. Data of type B may for example be data that were generated by a second modality of measuring like for example a medical imaging method. By means of a mapping step 504 a correlation between the value of a feature bᵢ, which is out of b₁ . . . bₖ, and between the value of a modality feature cⱼ, when the specimen is measured with the third modality C, is determined. This may be done for example by means of a mapping matrix which may for example be represented by a table as shown in FIG. 4. The match between the features may be characterized by weight in order to signal the strength of the match between the two features. Thereby the second modality of measuring 503, which is the modality B, is mapped to the third modality of measuring C by the mapping element M 504. This modality mapping is shown by 505. Furthermore, a translation of the B type features that have been weighted by means of the mapping are selected and form data of type C 508 in the adapted composite signature S′ which is illustrated by reference sign 507. The data of type A 502 may remain unchanged during that process.

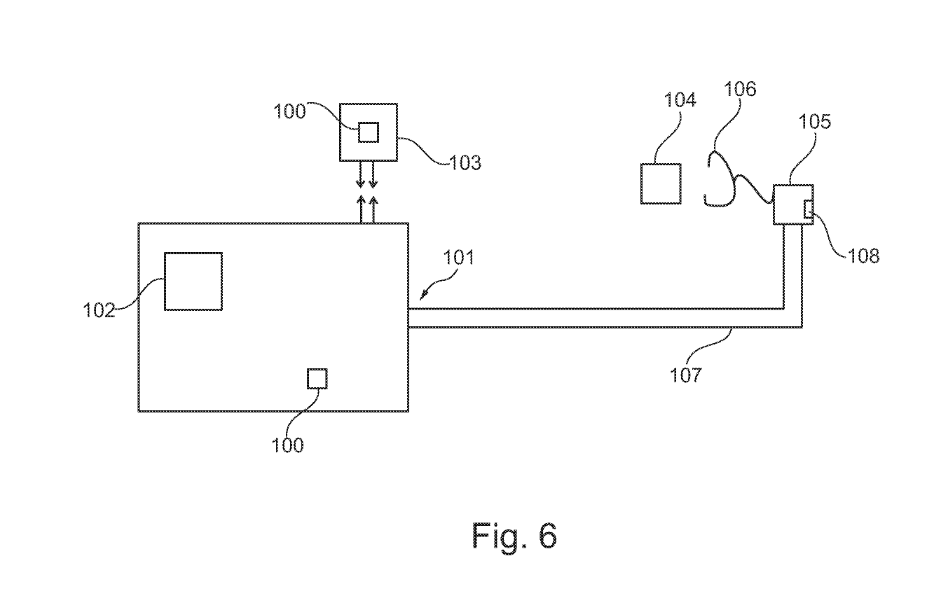

FIG. 6 schematically shows a computer system 101 that comprises a program element 100 for adapting a composite signature of a phenotype. This program element 100, when being executed by a processor, is adapted to carry out the previously described method steps. Furthermore, the processor 102 in the computer system 101 is shown. Additionally a computer-readable medium 103 is depicted in FIG. 6 in which a program element 100 for adapting a composite signature of a phenotype is stored. This program element 100 can be a computer program element and may also be executed by a plurality of processors. This may be the case if the program element is stored on a computer system which interacts or communicates with for example a medical imaging apparatus. The program element may also be stored on a medical imaging apparatus which medical imaging apparatus may then be instructed to carry out the previously described method steps. The medical apparatus 105 may comprise a sensor 106 in order to generate data of type B when performing a measurement or examination of the phenotype 104. Furthermore the medical imaging apparatus comprises a receiving section in order to receive data A of a first modality like e.g. genetic profiling data. A communication line 107 is shown between the computer system 101 and the medical imaging apparatus 105. Thereby, the medical imaging apparatus 105 may be adapted to carrying out for example the methods as described with respect to FIG. 1, FIG. 2 and/or FIG. 3. The medical imaging apparatus may be configured to generate a respective output after the adapted composite signature of the phenotype has been evaluated by the signature evaluation tool. Alternatively or additionally the medical imaging apparatus 105 may be configured to determine whether the phenotype is cancer or not base on the output after the application of the signature evaluation tool.

It has to be noted that exemplary embodiments of the invention are described with reference to different subject-matters. In particular, some exemplary embodiments are described with reference to apparatus type claims whereas other exemplary embodiments are described with reference to method type claims. However, a person skilled in the art will gather from the above and the following description that, unless otherwise notified, in addition to any combination of features belonging to one type of subject-matter also any combination between features relating to different subject-matters, in particular between features of the apparatus type claims and the features of the method type claims is considered to be disclosed with this application. However, all features can be combined providing synergetic effects that are more than the simple summation of the features. While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practising a claimed invention from a study of the drawings, the disclosure, and the appended claims. In the claims, the word “comprising” does not exclude other elements or steps and the indefinite article “a” or “an” does not exclude a plurality. A single processor or other unit may fulfil the functions of several items recited in the claims. The mere fact that certain measures are recited in mutually different dependent claims does not indicate that a combination of these features can not be used to advantage. Any reference signs in the claims should not be construed as limiting the scope of protection.

1. Method of adapting a composite signature of a phenotype which is derived from measurements of specimen, the method comprising the steps of:
providing for a composite signature of a phenotype,
wherein the composite signature comprises data of type A which were generated by measuring the specimen with a first modality of measuring,
wherein the data of type A comprise at least one value of modality features a₁ . . . a_{c},
wherein the composite signature comprises data of type B which were generated by measuring the specimen with a second modality of measuring,
wherein the data of type B comprise values of at least one modality features b₁ . . . bₖ,
adapting the value of the feature bᵢ based on a determined correlation between the value of modality feature bᵢ and between the value of a modality feature cⱼ when measured with a third modality of measuring,
wherein feature bᵢ is out of b₁ . . . bₖ,
wherein the adaption leads to an adapted composite signature of the phenotype, and
applying a signature evaluation tool to the adapted composite signature,
wherein the signature evaluation tool was derived from data measured by the third modality.

2. Method according to claim 1, further comprising the step
determining the correlation between the value of modality feature bᵢ
and between the value of a modality feature cⱼ when measured with a third modality of measuring the specimen.

3. Method according to claim 1,
wherein the correlation defines how values of features b₁ . . . bₖ of the second modality match or correlate with values of modality features cⱼ of the third modality, wherein cⱼ is out of c₁ . . . cₙ.

4. Method according to claim 1,
wherein the second modality of measuring is a first medical imaging method, and
wherein the third modality of measuring is a second medical imaging method.

5. Method according to claim 1,
wherein the second modality of measuring and the third modality of measuring are independently chosen from the group comprising ultrasound imaging, Doppler ultrasound imaging, X-ray imaging, MRI, PET, PAM (FTG), BSGI, transcription profiling, gene and/or noncoding RNA profiling, SNPs, CNPs, proteome profiling, DNA methylation, histone methylation profiling, acetylation, phosphorylation states, gene expression profiling, copy number polymorphism profiling, single nucleotide polymorphism profiling, histone acetylation profiling, proteomic profiling, phosphorylation state profiling, and any combination thereof.

6. Method according to claim 1,
further comprising the step
calculating a result about the nature of the phenotype based on the application of the signature evaluation tool to the adapted composite signature.

7. Method according to claim 1,
wherein the determination of the correlation is performed for several features b₁ . . . bₖ with respect to at least one feature out of c₁ . . . cₙ,
the method further comprising the step
selecting the features out of b₁ . . . bₖ whose determined correlation indicate a match with at least one feature out of c₁ . . . cₙ, wherein the match is above a predefined threshold.

8. Method according to claim 1,
further comprising the step
providing for a mapping matrix with matrix elements bcᵢⱼ,
providing for the composite signature of a phenotype in vector form, and
wherein the matrix elements bcᵢⱼ respectively indicate the determined correlation between the values of features bᵢ and cⱼ.

9. Method according to claim 1,
wherein the first modality is a method to obtain clinic-pathological data.

10. Method according to claim 9,
wherein the data of type A are clinic-pathological data,
further comprising the step
keeping the clinic-pathological data unchanged during the method.

11. Method according to claim 1, wherein the phenotype is cancer, further comprising the step
calculating a recurrence risk of the cancer by applying the signature evaluation tool to the adapted composite signature.

12. Method according to claim 1,
wherein the composite signature comprises data which is generated by at least two different modalities of measuring the specimen, the method making the composite signature usable for a signature evaluation tool that is derived from data measured by the third modality.

13. Medical imaging apparatus for adapting a composite signature of a phenotype which is derived from measurements of a specimen, wherein the medical imaging apparatus comprises:
a receiving section adapted to receive data of type A which were generated by measuring the specimen with a first modality of measuring;
an imaging device adapted to generate data of type B by measuring the specimen with a second modality of measuring,
wherein the medical imaging apparatus is configured to generate a composite signature of the phenotype,
wherein the composite signature comprises data of type A and type B,
wherein the data of type A comprise values of modality features a₁ . . . a_{q}
wherein the data of type B comprise values of modality features b₁ . . . bₖ,
wherein the medical imaging apparatus is configured to adapt the value of the feature bᵢ based on a determined correlation between the value of feature bᵢ and between the value of a feature cⱼ when measured with a third modality,
wherein feature bᵢ is out of b₁ . . . bₖ,
wherein the medical imaging apparatus is configured to generate an adapted composite signature,
wherein the medical imaging apparatus is configured to apply a signature evaluation tool to the adapted composite signature, and
wherein the signature evaluation tool was derived from data measured by the third modality.

14. Program element for adapting a composite signature of a phenotype, which is derived from measurements of a specimen ,which program element, when being executed by a processor is adapted to carry out:
receiving a composite signature of a phenotype in form of data,
wherein the composite signature comprise data of type A which were generated by a first modality of measuring the specimen,
wherein the data of type A comprises values of modality features a₁ . . . a_{q}
wherein the composite signature comprises data of type B which were generated by a second modality of measuring the specimen,
wherein the data of type B comprise values of modality features b₁ . . . bₖ,
adapting the value of the feature bᵢ which is out of b₁ . . . bₖ based on a determined correlation between the value of feature bᵢ and the value of a feature cⱼ when measured by a third modality,
wherein the adaption leads to an adapted composite signature,
applying a signature evaluation tool to the adapted composite signature, and
wherein the signature evaluation tool is derived from data measured by the third modality.

15. Computer readable medium, in which a program element for adapting a composite signature of a phenotype, which is derived from measurements of a specimen, is stored, which program element, when being executed by a processor is adapted to carry out:
receiving a composite signature of a phenotype in form of data,
wherein the composite signature comprise data of type A which were generated by a first modality of measuring the specimen,
wherein the data of type A comprises values of modality features a₁ . . . a_{c},
wherein the composite signature comprises data of type B which were generated by a second modality of measuring the specimen,
wherein the data of type B comprise values of modality features b₁ . . . bₖ,
adapting the value of the feature bᵢ which is out of b₁ . . . bₖ based on a determined correlation between the value of feature bᵢ and the value of a feature cⱼ when measured by a third modality,
wherein the adaption leads to an adapted composite signature,
applying a signature evaluation tool to the adapted composite signature, and
wherein the signature evaluation tool is derived from data measured by the third modality.
